(19) United States
(12) Patent Application Publication
(10) Pub. No.: US 2026/0078023 A1
(43) Pub. Date: Mar. 19, 2026

(54) FOREVER CHEMICAL REMOVAL BY FOAM FRACTIONATION IN A SPEECE CONE

(71) Applicant: ECO-OXYGEN TECHNOLOGIES, LLC, Indianapolis, IN (US)

(72) Inventors: Richard E. Speece, Nashville, TN (US); David Clidence, Carmel, IN (US); Garret Schleis, Golden Valley, MN (US)

(21) Appl. No.: 18/890,243

(22) Filed: Sep. 19, 2024

(51) Int. Cl. C02F 1/24; C02F 1/68; C02F 101/36

(52) U.S. Cl. CPC C02F 1/24; C02F 1/68; C02F 2101/36

(57) ABSTRACT

A system and method for removing at least one per- and poly-fluoroalkyl substance (PFAS) from water includes a foam fractionation system that creates foam in an incoming water flow of the water to create a foam containing liquid. The foam containing liquid is injected into a top side of a downflow cone, such as a Speece cone. The foam containing liquid is flowed through the downflow cone at a predetermined velocity to create and immobilize a bubble swarm within the downflow cone. The treated liquid is removed from a bottom side of the downflow cone, where the treated liquid has a lower concentration of the PFAS as compared to the concentration in the incoming water flow. Foam is removed from the downflow cone, where the foam includes the PFAS removed from the water.

### BACKGROUND OF THE INVENTION

### 1. Field of the Invention

Embodiments of the invention relate generally to treatment of liquids, such as water. More particularly, embodiments of the invention relate to methods and systems for the removal of forever chemicals, such as per- and poly-fluoroalkyl substances (PFAS), by foam fractionation in a downflow cone, such as a Speece cone.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The forever chemicals, such as PFAS, have been shown to have adverse health effects, and unfortunately, are ubiquitous in the environment. PFAS have been used for decades in consumer products to make them non-stick and water resistant. They are also found in firefighting foams and are applied in many industrial processes. Unfortunately, the characteristics that make them useful are the reason they persist in the environment and can bioaccumulate in humans and the bodies of animals.

PFAS also dissolve in water, and combined with their chemical properties mean traditional drinking water treatment technologies are not able to remove them. Conventional technologies, such as activated carbon adsorption, ion exchange resins, and high-pressure membranes, have been found to remove PFAS from drinking water. These processes, however, may prove costly and may require regular maintenance.

In view of the foregoing, there is a need for improved methods and systems for removing PFAS from water.

### SUMMARY OF THE INVENTION

Embodiments of the present invention provide a method for removing a chemical from a liquid in a first foam fractionation system, the chemical being present in the liquid at a first concentration, the method comprising creating foam in an incoming liquid flow of the liquid to create a foam containing liquid; injecting the foam containing liquid into a top side of a conical shaped vessel, wherein the top side is a narrow end of the conical shaped vessel; flowing the foam containing liquid through the conical shaped vessel at a predetermined velocity to create a bubble swarm within the conical shaped vessel; removing treated liquid from a bottom side of the conical shaped vessel, the treated liquid having a second concentration of the chemical that is less than the first concentration; and removing foam from the conical shaped vessel, the foam including the chemical removed from the liquid.

Embodiments of the present invention provide a method for removing at least one per- and poly-fluoroalkyl substance (PFAS) from water in a first foam fractionation system, the PFAS being present in the water at a first concentration, the method comprising creating foam in an incoming water flow of the water to create a foam containing liquid; injecting the foam containing liquid into a top side of a downflow cone, such as an oxygenation cone or a Speece cone, wherein the top side is a narrow end of the downflow cone; flowing the foam containing liquid through the conical shaped vessel at a predetermined velocity to create a bubble swarm within the conical shaped vessel; removing treated liquid from a bottom side of the conical shaped vessel, the treated liquid having a second concentration of the PFAS that is less than the first concentration; removing foam from the conical shaped vessel, the foam including the PFAS removed from the liquid; and treating the treated liquid with a biological treatment system for removing the foaming agent from the treated liquid. The effluent from the biological treatment system may then need to be further polished by a more expensive physical treatment system, such as granular activated carbon, to meet the low concentration specified by the regulatory agency.

Embodiments of the present invention provide a foam fractionation system for removing at least one per- and poly-fluoroalkyl substance (PFAS) from water, the PFAS being present in the water at a first concentration comprising a foam generator creating foam in an incoming water flow of the water to generate a foam containing liquid; an downflow cone having a top side receiving the foam containing liquid, wherein the top side is a narrow end of the downflow cone, the downflow cone slowing flow of the foam containing liquid therethrough as the foam containing liquid moves toward a discharge at a bottom side of the downflow cone, wherein a treated liquid exits the discharge of the downflow cone; a bubble swarm formed in the downflow cone, the bubble swarm created in an area where a downward flow of the foam containing liquid matches an upward velocity of bubbles of the bubble swarm; and a bubble harvester removing foam containing the PFAS from the downflow cone, wherein the treated liquid has a second concentration of PFAS that is lower than the first concentration.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of a water treatment system according to an exemplary embodiment of the present invention; and

FIG. 2 illustrates a schematic representation of multiple foam fractionation units used in series to further decrease PFAS concentration in water, according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a method for the effective removal of chemicals, such as PFAS, from the water via foam fractionation. Foam fractionation introduces bubbles into the water and the chemicals migrate to the gas/water interface because of the adsorptive characteristics of the chemicals. Unlike conventional processes, where bubbles are introduced to the water and characteristically are injected at the bottom of a water column. As the bubbles rise to the surface, these chemicals migrate/concentrate to the bubble/water interface. The bubbles are then harvested and disposed of by some means to remove the forever chemicals from the main flow of water.

To optimize the removal efficiency, a greater ratio of air/water interface is beneficial. Two ways to increase the air/water interface is accomplished by reduction of the bubble size and/or increase of the bubble/water ratio. Increasing the bubble/water (foam) surface area by smaller bubbles can be accomplished by adding a surfactant and/or recycle of a super saturation of a sidestream with dissolved gas.

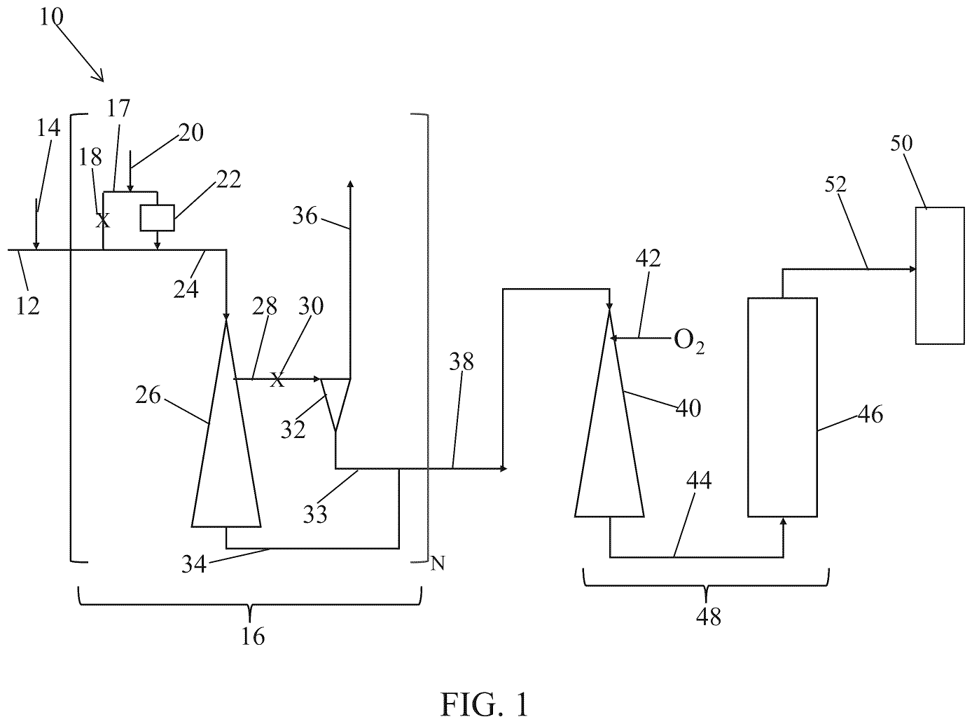

As shown in FIG. 1, a system 10 for removal of chemicals from an incoming liquid stream 12 is illustrated. The incoming liquid stream 12 may be a water stream that has a concentration of PFAS that is desired to be removed therefrom. A foaming agent 14, such as a biodegradable foaming agent, may be injected into the incoming liquid stream 12.

A sidestream 17, controlled by a valve 18, can have an air injection 20 and a bubble generator 22 for creating air bubbles in the incoming liquid stream 12. An outflow 24 may be introduced into an downflow cone 26, also referred to as a Speece cone 26. In removal of chemicals, such as PFAS, using the downflow cone 26, the bubbles are introduced into the top of the cone 26, by some means. Increased bubble/water surface area can be accomplished by their concentration in a downflow bubble contactor, such as the Speece cone 26. The way in which this works is that as water passes down an inverted conical shaped vessel (of which the downflow cone 26 is an example thereof), the expanding surface area results in reduced downward water velocity. When the downward water velocity is less than the buoyant velocity of the bubbles in the bubble swarm, the bubbles can be concentrated and retained indefinitely in this inverted conical reactor. In this way, the bubble swarm is immobilized to increase the bubble concentration and thus enhance absorptive removal of the chemicals at the bubble/water surface. The bubble swarm inside the downflow cone 26 can create a foam having the chemical desired to be removed from the incoming liquid stream 12 (such as PFAS) concentrated in the foam.

As discussed above, it may be advantageous to introduce a biodegradable foaming agent 14, such as a surfactant/detergent, to stabilize the bubbles and prevent their coalescence into larger bubbles with markedly reduced surface interfacial area between the bubbles and the water. The bubble swarm, thus immobilized in the downflow conical reactor, has a greatly enhanced gas/water interface through which the water to be treated is passed. This, in turn, enhances chemical removal efficiency.

Judicious selection of the foaming agent 14 to stabilize the bubble swarm conceivably could markedly enhance removal of the forever chemical as well due to the concentration of the surfactant on the bubble water interface. This is because of the potential of the enhanced solubility of the chemical in the surfactant itself which also concentrates at the bubble surface. Non-limiting examples of foaming agents include foaming agents from different surfactant classes, having anionic (sodium dodecyl sulphate (SDS)), non-ionic (Triton X-100), zwitterionic (Lauryl sulfobetaine (SB3-12)) and cationic (cetyltrimethylammonium bromide (CTAB)) headgroups.

A bubble harvester can be used to withdraw foam liquid from the Speece cone 26 at a location of a foam liquid withdrawal line 28, which may be controlled by a valve 30. When the foam grows inside the downflow cone 26 and reaches the liquid withdrawal line 28, the foam can exit the downflow cone. The location of the foam liquid withdrawal line 28 may be, for example, at a location which has the highest foam concentration. By withdrawing or harvesting the bubble swarm (foam), the chemical so removed by foam fractionation is removed from the water flow 34 that can exit the bottom (or adjacent the bottom) of the Speece cone 26. Harvest of the foam containing the absorbed chemical removes it from the water flow.

The harvested foam, via line 28, can then be passed into a concentration reactor 32 where the excess liquid 33 is removed from the foam and returned to the discharge (the water flow 34) from the Speece cone 26. This disposal product can be removed by line 36, for example. The foam in the concentration reactor 32 is concentrated, which means its water content is reduced, and there is less volume of foam for final disposal. This can be important if the foam destruction method is incineration because it means there is less water to be evaporated and less energy therefore required to be input into the system.

If a foaming agent detergent is added to stabilize the foam so that it doesn't coalesce into larger bubbles, the final effluent 38 can be treated in a biological treatment system 48 for removal of residual foaming agent from the final product water.

This final treatment system for removal of residual detergent could be an aerobic, submerged media reactor 40 in which oxygen 42 is dissolved to provide an oxygenated output 44 support aerobic biodegradation in an upflow, submerged biological reactor 46. The output 52 may be released as treated liquid, such as treated water that has a significant reduction in PFAS concentration. In some embodiments, the output 52 may pass through an optional physical treatment system 50, such as granular activated carbon to meet the low concentration of PFAS as specified by a regulatory agency. As used herein, the term “significant reduction” may refer to a reduction in the PFAS concentration of at least 50 percent. In some embodiments, the significant reduction may be a reduction in the PFAS concentration of at least 75 percent. In some embodiments, the significant reduction may be a reduction in the PFAS concentration of at least 80 percent. In some embodiments, PFAS reduction may be achieved upwards to 95 to 99 percent concentration reduction. The reduction in PFAS concentration may be determined by comparing a concentration of a specific PFAS (or a plurality of PFAS) at the incoming liquid stream 44 to the concentration at the output 48.

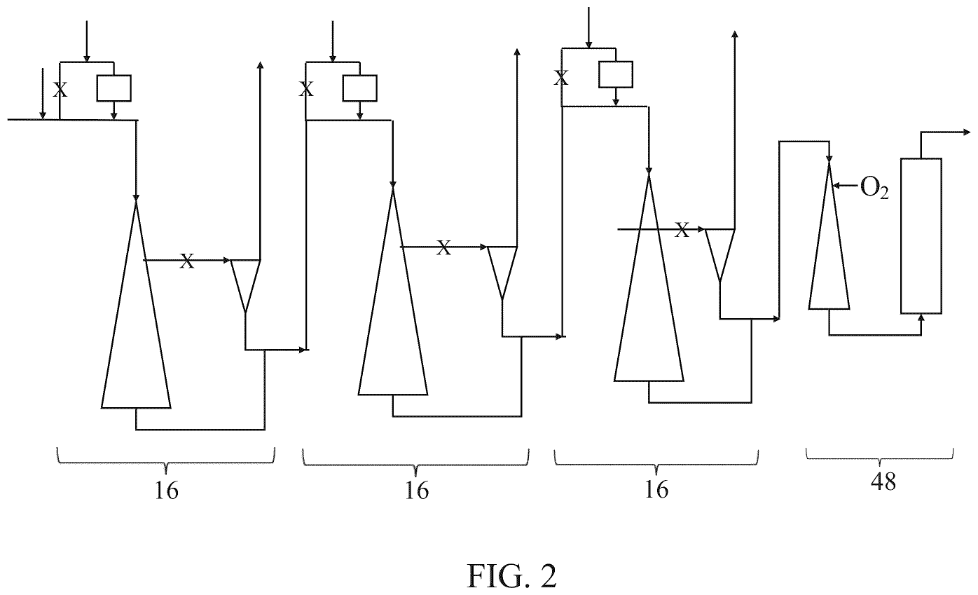

As shown in FIG. 1, by having an N-number of foam fractionation systems 16, and, as specifically illustrated in FIG. 2, with three foam fractionation systems 16 connected in series, enhanced removal of the forever chemical could be accomplished by staging two or more Speece Cones in series to gain kinetic removal efficiency.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for removing a chemical from a liquid in a first foam fractionation system, the chemical being present in the liquid at a first concentration, the method comprising:
creating bubbles in an incoming liquid flow of the liquid to create a bubble containing liquid;
injecting the bubble containing liquid into a top side of a conical shaped vessel, wherein the top side is a narrow end of the conical shaped vessel;
flowing the bubble containing liquid through the conical shaped vessel at a predetermined velocity to create a bubble swarm within the conical shaped vessel;
removing treated liquid from a bottom side of the conical shaped vessel, the treated liquid having a second concentration of the chemical that is less than the first concentration; and
removing foam generated by the bubble swarm from the conical shaped vessel, the foam including the chemical removed from the liquid.

2. The method of claim 1, further comprising adding a foaming agent to the incoming liquid flow prior to creating the bubbles.

3. The method of claim 2, further comprising treating the treated liquid with a biological treatment system for removing the foaming agent from the treated liquid.

4. The method of claim 1, further comprising removing water from the removed foam to concentrate the foam containing the chemical.

5. The method of claim 4, further comprising reintroducing the removed water into the treated liquid.

6. The method of claim 1, wherein the conical shaped vessel is a downflow cone.

7. The method of claim 6, wherein the downflow cone is a Speece cone.

8. The method of claim 1, wherein the liquid is water.

9. The method of claim 1, wherein the chemical is at least one per- and poly-fluoroalkyl substance (PFAS).

10. The method of claim 1, wherein the second concentration is at least 50 percent less than the first concentration.

11. The method of claim 1, further comprising injecting air into the liquid to create air bubbles with a foam generator.

12. The method of claim 1, further comprising passing the treated liquid through, in series, one or more second foam fractionation systems, each of the one or more second foam fractionation systems performing steps of:
adding a foaming agent to the incoming liquid flow;
creating bubbles in the treated liquid to create a second bubble containing treated liquid;
injecting the second bubble containing treated liquid into a top side of a second conical shaped vessel, wherein the top side is a narrow end of the second conical shaped vessel;
flowing the bubble containing treated liquid through the second conical shaped vessel at a predetermined velocity to create a second bubble swarm within the second conical shaped vessel;
removing a second treated liquid from a bottom side of the second conical shaped vessel, the second treated liquid having a third concentration of the chemical that is less than the second concentration; and
removing foam generated by the bubble swarm from the second conical shaped vessel, the foam including the chemical removed from the liquid.

13. A method for removing at least one per- and poly-fluoroalkyl substance (PFAS) from water in a first foam fractionation system, the PFAS being present in the water at a first concentration, the method comprising:
creating bubbles in an incoming water flow of the water to create a bubble containing liquid;
injecting the bubble containing liquid into a top side of a downflow cone, wherein the top side is a narrow end of the downflow cone;
flowing the bubble containing liquid through the downflow cone at a predetermined velocity to create a bubble swarm within the downflow cone;
removing treated liquid from a bottom side of the downflow cone, the treated liquid having a second concentration of the PFAS that is less than the first concentration;
removing foam generated by the bubble swarm from the downflow cone, the foam including the PFAS removed from the liquid; and
treating the treated liquid with a biological treatment system for removing the foaming agent from the treated liquid.

14. The method of claim 13, further comprising:
removing water from the removed foam to concentrate the foam containing the PFAS; and
reintroducing the removed water into the treated liquid.

15. The method of claim 13, wherein the second concentration is at least 50 percent less than the first concentration.

16. The method of claim 13, further comprising passing the treated liquid through, in series, one or more second foam fractionation systems, each of the one or more second foam fractionation systems performing steps of:
creating bubbles in the treated liquid to create a second bubble containing treated liquid;
injecting the second bubble containing treated liquid into a top side of a second downflow cone, wherein the top side is a narrow end of the second downflow cone;
flowing the bubble containing treated liquid through the second downflow cone at a predetermined velocity to create a second bubble swarm within the second downflow cone;
removing a second treated liquid from a bottom side of the second downflow cone, the second treated liquid having a third concentration of the PFAS that is less than the second concentration; and
removing foam from the second downflow cone, the foam including the PFAS removed from the liquid.

17. A foam fractionation system for removing at least one per- and poly-fluoroalkyl substance (PFAS) from water, the PFAS being present in the water at a first concentration, the system comprising:
a foam generator creating foam in an incoming water flow of the water to generate a bubble containing liquid;
a downflow cone having a top side receiving the bubble containing liquid, wherein the top side is a narrow end of the downflow cone, the downflow cone slowing flow of the bubble containing liquid therethrough as the bubble containing liquid moves toward a discharge at a bottom side of the downflow cone, wherein a treated liquid exits the discharge of the downflow cone;
a bubble swarm formed in the downflow cone, the bubble swarm created and maintained in an area where a downward flow of the bubble containing liquid matches an upward velocity of bubbles of the bubble swarm; and
a bubble harvester removing foam, created by the bubble swarm, containing the PFAS, from the downflow cone, wherein
the treated liquid has a second concentration of PFAS that is lower than the first concentration.

18. The foam fractionation system of claim 17, further comprising a foaming agent disposed in the water before the water reaches the foam generator.

19. The foam fractionation system of claim 17, further comprising a biological treatment system for removing the foaming agent from the treated liquid.

20. The foam fractionation system of claim 17, further comprising a concentration reactor operable to remove water from the removed foam to concentrate the foam containing the PFAS and reintroduce the removed water into the treated liquid.
